(19) United States
(12) Patent Application Publication
(10) Pub. No.: US 2024/0189182 A1
(43) Pub. Date: Jun. 13, 2024

(54) Pressure point device

(71) Applicant: Nicholas Greener, Ham Lake, MN (US)

(72) Inventor: Nicholas Greener, Ham Lake, MN (US)

(21) Appl. No.: 18/080,048

(22) Filed: Dec. 13, 2022

(51) Int. Cl. A61H 39/04

(52) U.S. Cl. CPC A61H 39/04; A61H 2201/01; A61H 2201/165; A61H 2205/065

(57) ABSTRACT

A device and method for providing therapeutic pressure to one or more locations on a user's hand, the device comprising a top portion and bottom portion, each of the top and bottom portion terminating on a front end in a pressure point surface and each of the top and bottom portion terminating on a rear end in a handle portion.

### BACKGROUND

The present invention relates to a therapeutic device and more specifically to a device configured to apply pressure to one or more pressure points on a user.

The practice of using pressure points to address one or more physical states is known as reflexology and can tie into acupuncture and which use the study how one part of the human body relates to another to treat some conditions. It is believed that many powerful pressure points are in the hands. However, there exist few tools to assist a user with reflexology on their own.

### SUMMARY

An aspect of the present disclosure relates to a device for providing therapeutic pressure to one or more locations on a user's hand, the device comprising a top portion and bottom portion, each of the top and bottom portion terminating on a front end in a pressure point surface and each of the top and bottom portion terminating on a rear end in a handle portion.

The pressure point surface of each of the top and bottom portion are opposing surfaces.

The pressure point surfaces are biased towards one another.

The handle portion of each of the top and bottom portion are opposing handle portions.

The handles are configured such that when a space between the handles is manually decreased a space between the point surfaces is increased.

The pressure point surfaces are configured to clamp a location on a hand, such as the hand valley therebetween and apply pressure thereto.

The pressure point surfaces are smooth.

The pressure point surfaces are textured.

The pressure point surfaces are curved.

The top portion and the bottom portion are pivotally connected by a resilient and flexible member extending between an inner facing surface of the top portion and an inner facing surface of the lower portion.

The resilient and flexible member is curved and substantially smooth.

The device does not include a spring mechanism for biasing the pressure point surfaces towards one another.

The device has dimensions configured to fit within the space between a relaxed thumb and index finger on a same hand.

Another aspect of the present disclosure relates to a method of self-administering therapeutic acupressure and/or hand reflexology. The method includes providing controlled therapeutic pressure to a pressure point on a hand. A device manually biases two opposing handles towards one another to increase a space between two pressure point surfaces as a user inserts the pressure point on the hand between the two pressure point surfaces. Releasing the manual bias applied to the two opposing handles automatically decreases the space between the two pressure point surfaces applies the therapeutic pressure to the pressure point.

Inserting the device into a space between a user's hand and index finger to applies pressure to the pressure point wherein the pressure point is a LI-4 pressure point.

Applying the therapeutic pressure to the pressure point with the device is carried out one or more times for a duration of one to five minutes each time.

### BRIEF DESCRIPTION OF THE DRAWINGS

FIG. 1 is a front view of the device.

FIG. 2 is a side view of the device.

FIG. 3 is a perspective view of the device in use.

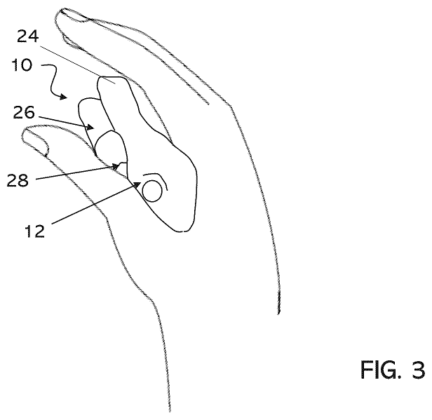

### DETAILED DESCRIPTION

Illustrated in the figures is a device designed to apply pressure to one or more locations on the hand of a user. In one embodiment, the device is specifically configured to apply pressure to the area between a user's thumb and index finger. This location may be known as the “hand valley” and the device described herein configured to apply pressure to the hand valley point. This pressure point may be related to the reduction of stress as well as the alleviation of headaches, migraines, toothaches, shoulder tension and neck pain.

The device includes a top portion and a bottom portion. The top portion has a front end comprising a first pressure point surface and a rear end comprising a first handle portion. Similarly, the bottom portion has a front end comprising an opposing, second pressure point surface and a rear end comprising an opposing, second handle portion. The front end of the device is thus configured for clamping a portion of the user's hand, or a pressure point, between the first, or top portion pressure point surface and the second, or bottom portion pressure point surface. The rear end of the device is configured in a manner that allows a user to push the first, or top handle portion and the second, or bottom handle portion together to open a space between the first and second pressure point surfaces for inserting the pressure point therebetween. The pressure point may be a pressure point on the user's hand, such as the LI-4 pressure point also referred to as the Hegu point and/or the pressure point(s) on a user's “hand valley” between the thumb and index finger. When the top and bottom handles are released, the front end first and second pressure point surfaces return to a closed position with the pressure point clamped therebetween and force and/or pressure applied evenly and continuously to the pressure point while the device is worn. Removal of the device requires manually forcing the handles together to open the space between the first and second pressure point surface and removing the pressure point therefrom.

The top portion and bottom portion are connected at a location spaced apart from the rear end and the front end of the device. This connection point provides a bias to the front end first and second pressure point surfaces to bias these surfaces together in a clamped or closed position when the device is “relaxed” or when no pressure is applied to force the first and second handle portions together. The connection point may be a pivot point between the top portion and bottom portion.

In one embodiment the device requires gentle manual force to force the handles towards one another to increase the space between the two opposing pressure point surfaces for inserting the pressure point therebetween. Thus, when in use, the manual force is removed from the handles and a therapeutic pressure is applied to the inserted pressure point automatically by the device and without requiring external manual clamping force on the two pressure point surfaces.

The device is configured to provide pressure to the pressure point sufficient for acupressure and/or pressure point therapy. The amount of pressure applied by the device at the two opposing pressure point surfaces, when worn, may be controlled by the position of the pivot point with respect to the location and spacing from the pressure point surfaces, the curvature of the pivot point, the surface area of the pressure point surfaces, or combinations thereof. The pressure applied is only enough pressure to impart some sensation to the user, but not enough pressure that it causes pain to the user. Thus, the device is able to provide firm and consistent pressure to the user when worn.

For example, in one or more embodiments, the device may be configured to apply a therapeutic and consistent amount of pressure to the selected pressure point, where what is meant by “therapeutic” levels of pressure throughout this disclosure is an amount of pressure that is considered gentle pressure but sufficient pressure to stimulate the selected pressure point to provide one or more of stress relief, muscular tension relief, induce relaxation, headache relief, and promoting the natural functioning of the body. The therapeutic pressure does not pinch the skin nor is the pressure or force applied sufficient to cause injury and/or pain. These therapeutic levels of pressure referred to herein and substantially akin to gentle and firm pressure applied by the hand of a practitioner skilled in acupressure and/or reflexology.

The device may have overall dimensions which allow the device to fit within the space between the thumb and index finger comfortably. For example, the user's hand, in a relaxed position and with the device clamped onto the user's hand valley may fit unobstructed or substantially unobstructed between the thumb and index finger. The length of the device may be sufficient such that the device does not extend past a tip of a user's thumb when worn. For example, the overall dimensions of the device may be less than about 3 inches long, less than about 1.5 inches wide at a widest point and may weigh less than about 10 grams. In one embodiment, the device having dimensions for a standard adult hand is approximately 2 inches long and 1 inch across at the widest point of the device. The device then weighs approximately 8.7 grams.

One or both pressure point surfaces may be textured and/or otherwise provided with a non-smooth and/or non-flat surface topography in order to increase the grip and/or co-efficient of friction between the device in a clamped position on a user's hand. The one or both pressure point surfaces may also be raised surfaces on the top portion and/or bottom portion where the pressure point surfaces protrude into a space for the insertion of the user's pressure point. The pressure point surfaces may also be curved or otherwise raised and/or textured.

The device may also have a space between the top portion and the bottom portion between the pressure point surfaces and the connection mechanism wherein a user's hand valley may sit when the user wears the device on their pressure point. This space may have one or more smooth and/or curved surfaces such that an inner portion of the device does not have any edges or sharp surfaces and thus provides an ergonomic and comfortable fit when worn. Outer surface of the device may be similarly rounded and lacking in any edges, corners etc.

The top portion and bottom portion may have the same length and/or width but may have the same or different heights or surface dimensions along the length and/or width.

The device may be a single, unitary and monolithic construction, that is, the device may be manufactured by molding or 3D printing and without the requirement of fasteners or other mechanism to secure the top portion and the bottom portion together. Instead, the top portion and the bottom portion may be resiliently connected about a mechanism that allows for a pivot action between the top and bottom portions to open the space between the pressure point surfaces for donning the device for use. This mechanism is provided at the pivot point between the top portion and the bottom portion and the mechanism may be rounded and substantially smooth. This mechanism may comprise an arcuate surface that extends from the top to the bottom portion at location along a center of the length of the device. This aids in the smooth movement of the pressure point surfaces with respect to one another and eliminates the possibility of a user's skin being clipped or pinched by a pivoting mechanism. Moreover, this increases comfort of the device when worn as the user's hand may contact this mechanism depending on selected placement of the pressure point surface and would do so without a rough, sharp, or edged surface to contact the user's hand or without other surfaces which compress and could pinch a user's skin therebetween.

The device may be comprised of only a single material such as a plastic or resin and/or may have one or more coatings or other materials thereon, such as applied to the pressure point surfaces to increase comfort and/or grip.

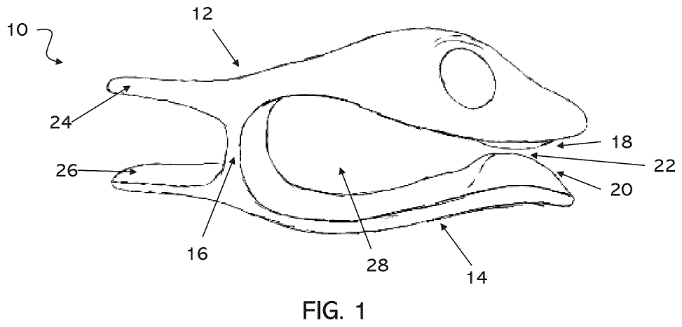

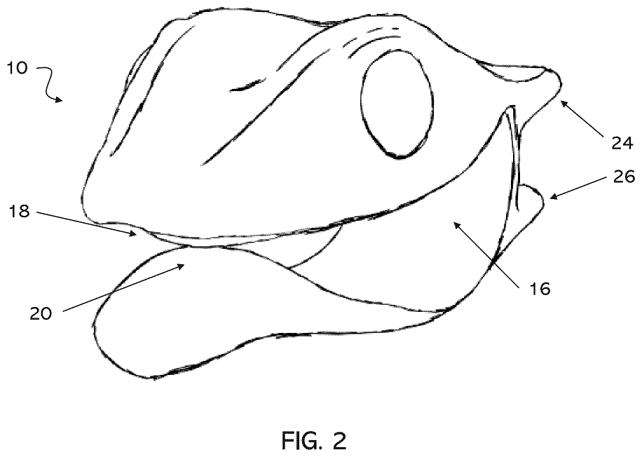

Referring to the embodiment illustrated in FIGS. 1-2, the device 10 comprises a top portion 12 and a bottom portion 14 integrally connected to one another in a movable and/or pivoting manner at the connection mechanism 16. The connection mechanism 16 is an arcuate surface that is resilient for automatically returning the device 10 to a relaxed state where a first pressure point surface 18 and a second pressure point surface 20 are forced towards one another, a space 22 between the two pressure point surfaces 18, 20 being reduced. A first handle portion 24 and a second handle portion 26 allow for manual opening of the space 22 between the pressure point surfaces 18 and 20 for applying and removing the device 10 from a pressure point.

The device 10 also comprises an open area 28 between the top portion 12 and bottom portion 14 that does not have any corners or edges, and which provides an injury preventing surface for insertion of a user's hand or hand valley.

Although the present disclosure has been described with reference to preferred embodiments, workers skilled in the art will recognize that changes may be made in form and detail without departing from the spirit and scope of the disclosure.

1. A device for providing therapeutic pressure to one or more locations on a user's hand, the device comprising a top portion and bottom portion, each of the top and bottom portion terminating on a front end in a pressure point surface and each of the top and bottom portion terminating on a rear end in a handle portion.

2. The device of claim 1 wherein the pressure point surface of each of the top and bottom portion are opposing surfaces.

3. The device of claim 2 wherein the pressure point surfaces are biased towards one another with a mechanism connecting the top portion and the bottom together and wherein the mechanism is substantially smooth and curved.

4. The device of claim 1 wherein the handle portion of each of the top and bottom portion are opposing handle portions.

5. The device of claim 1 wherein the handles are configured such that when a space between the handles is manually decreased, a space between the point surfaces is increased.

6. The device of claim 1 wherein the pressure point surfaces are configured to clamp a pressure point on a hand therebetween and apply therapeutic pressure thereto.

7. The device of claim 1 wherein the pressure point surfaces are smooth.

8. The device of claim 1 wherein the pressure point surfaces are textured.

9. The device of claim 1 wherein the pressure point surfaces are curved.

10. The device of claim 1 wherein the top portion and the bottom portion are pivotally connected by a resilient and flexible member extending between an inner facing surface of the top portion and an inner facing surface of the lower portion.

11. The device of claim 10 wherein the resilient and flexible member is curved and substantially smooth.

12. The device of claim 1 wherein the device does not include a spring mechanism for biasing the pressure point surfaces towards one another.

13. The device of claim 1 wherein the device has dimensions configured to fit within a space between a relaxed thumb and index finger on a same hand.

14. A method of providing controlled therapeutic pressure to a pressure point on a hand, the method comprising:
manually biasing two opposing handles towards one another to increase a space between two pressure point surfaces;
inserting the pressure point on the hand between the two pressure point surfaces; and
releasing the manual bias applied to the two opposing handles to automatically decrease the space between the two pressure point surfaces; and
applying the therapeutic pressure to the pressure point.

15. The method of claim 14 and further comprising inserting the device into a space between a user's hand and index finger to apply pressure to the pressure point wherein the pressure point is a LI-4 pressure point.

16. The method of claim 14 and applying the therapeutic pressure to the pressure point with the device one or more times for a duration of one to five minutes each time.
